(19) United States
(12) Patent Application Publication
(10) Pub. No.: US 2012/0171934 A1
(43) Pub. Date: Jul. 5, 2012

(54) CRYOGENIC FLUID STREAM DISPENSING DEVICE WITH POLYMER JOINT HAVING GIVEN EXPANSION COEFFICIENT

(75) Inventors: Jacques Quintard, Presles (FR); Frederic Richard, Parmain (FR); Charles Truchot, Poissy (FR)

(73) Assignee: L'Air Liquide Societe Anonyme Pour L'Etude Et L'Exploitation Des Procedes Georges Claude, Paris (FR)

(21) Appl. No.: 13/395,749

(22) PCT Filed: Sep. 15, 2010
(86) PCT No.: PCT/FR2010/051909

§ 371 Date: Mar. 13, 2012

(30) Foreign Application Priority Data
Sep. 23, 2009 (FR) 0956537

(51) Int. Cl. B24C 1/00; F17C 13/00; F17C 7/02

(52) U.S. Cl. 451/39; 62/50.7; 62/52.1

(57) ABSTRACT

The invention relates to a device for dispensing at least one high-pressure cryogenic fluid stream, said device including a movable tool, comprising one or more fluid-dispensing nozzles for dispensing one or more high-pressure cryogenic fluid streams, and a line for supplying high-pressure cryogenic fluid from the movable tool, said line including a stationary upstream portion and a movable downstream portion that is connected to the movable tool, said stationary upstream portion and movable downstream portion being fluidly connected to each other by means of a rotatable system including a rotating joint. The rotating joint includes a polymer material having a heat expansion coefficient between 10×10⁶ and 160×10^{″6}/K.

The invention relates to a device and a working method using jets of high-pressure cryogenic fluid, in particular for surface treating, paint stripping, or scarifying, comprising a rotary seal with a given coefficient of expansion and a given coefficient of friction.

The use is disclosed, for example in the documents U.S. Pat. No. 7,310,955 and U.S. Pat. No. 7,316,363 of one or more very high-pressure cryogenic jets in order to carry out surface treatments of materials which may or may not be covered with material, in particular paint stripping, scarifying, or the like, but also operations in which material, such as metal, concrete, wood, polymer, ceramic, plastic or any other kind of material, is cut.

This type of method is intended to be used in particular in environments where there are major environmental constraints, such as in nuclear or chemical environments.

The jet or jets of liquid nitrogen at a pressure of 1000 to 4000 bar and a cryogenic temperature between, for example, −100 and −200° C., and typically between approximately −140 and −160° C., are dispensed by a nozzle-bearing tool which can be fixed or moved in a rotating or oscillating motion and which is generally supplied with liquid nitrogen through a cryogenic fluid feed duct.

In order to obtain a rotating motion of the tool, a rotating motion about the axis of the line is imparted to the duct and the tool by means of a rotary drive system with pinions or belts moved by a motor.

The dynamic sealing of the rotating system is usually effected by a rotating cylindrical seal, typically made from Tivar®, arranged about the duct, traversed longitudinally by a bronze part, and surrounded by a solid stainless-steel part.

It has been noticed in practice that this seal becomes less effective over time, because of the cryogenic temperatures employed which are typically below approximately −150° C., which relatively quickly causes leaks and hence makes the process less efficient, in particular during operations where concrete is being chipped off or paint is being stripped, for example.

Indeed, the materials deform differently under the effect of the cryogenic temperatures employed, depending on their respective coefficient of thermal expansion, as illustrated in Table I.

TABLE I
Coefficient of thermal expansion (×10⁻⁶/K)

| Tivar ®* | Stainless steel 316 | Bronze |
|---|---|---|
| 180 | 15 (NIST = 24) | 17.5 |

*Tivar ® is an ultra-high molecular weight polyethylene.

These values are valid and assumed to be constant for the temperature range in question. The coefficients of thermal expansion per unit length are obtained in accordance with DIN 50044.

As can be seen, these materials react very differently to the cryogenic temperatures and, consequently, deformations or even damage can occur to the seal during the alternate cooling and heating cycles and this happens even more quickly when it is subjected to very high pressures, namely up to typically 4000 bar.

Indeed, it has been noted in practice that play gradually occurs between the seal and the metal parts which causes leaks that prevent the system from operating normally. Consequently, the seal needs to be replaced regularly, which incurs equipment and maintenance costs. Now this is a critical factor in hazardous environments, for example in particular nuclear or chemical contexts, where human intervention must be kept to a minimum.

The object of the invention is thus to increase the reliability of a system for dispensing cryogenic fluid, in particular liquid nitrogen, as described above, by providing a dispensing system with a fluid dispensing tool having a rotary seal that has been improved so as to overcome the abovementioned disadvantages.

The object of the invention is achieved by a device for dispensing at least one jet of high-pressure cryogenic fluid, comprising:
a movable tool which has one or more fluid dispensing nozzles for dispensing one or more jets of high-pressure fluid at a cryogenic temperature, and
a line for supplying the movable tool with high-pressure fluid at a cryogenic temperature comprising a stationary upstream portion and a movable downstream portion joined to the movable tool, said stationary upstream portion and a movable downstream portion being fluidically connected to each other by means of a rotary system comprising a rotating seal,
characterized in that the rotating seal is made from a polymeric material with a coefficient of thermal expansion of between 10.10⁻⁶ and 160.10⁻⁶/K.

Depending on circumstances, the device of the invention can comprise one or more of the following features:
the rotating seal is made from a polymeric material with a coefficient of thermal expansion of between 20.10⁻⁶ and 130.10⁻⁶/K.
the rotating seal is made from a polymeric material with a coefficient of friction that is less than 0.50.
the seal is cylindrical in shape.
the seal is held within the rotary system by one or more metal parts.
the seal is made from a polymeric material which can be chosen from PTFE, PCTFE, PAI and PPS.

The invention also relates to an installation for dispensing at least one jet of high-pressure fluid at a cryogenic temperature comprising a device according to the invention which is supplied with cryogenic fluid by a source of fluid at a cryogenic temperature and comprises a tool which is capable of rotational movement and is equipped with one or more nozzles for dispensing said pressurized cryogenic fluid.

Furthermore, the invention also relates to a method for surface treating, stripping, or scarifying a material using jets of high-pressure cryogenic fluid, in which an installation or a device according to the invention is used.

The cryogenic fluid dispensed by the nozzle or nozzles of the tool is preferably at a pressure of at least 500 bar, preferably between 2000 and 4000 bar.

The fluid dispensed by the nozzle or nozzles of the tool is advantageously at a temperature below −140° C., preferably between approximately −140 and −180° C.

The invention will now be understood with the aid of the following illustrative embodiments which are given with reference to the attached Figures, in which:

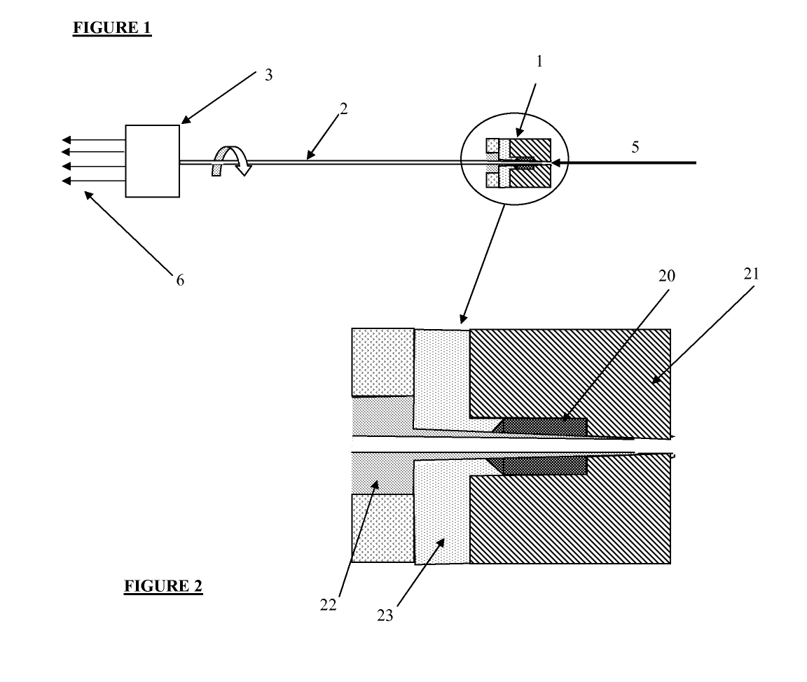

FIG. 1 is a schematic view of part of a device for dispensing jets of high-pressure fluid at a cryogenic temperature which is equipped with a seal according to the invention,

FIG. 2 is an enlarged schematic view of the seal according to the invention in FIG. 1,

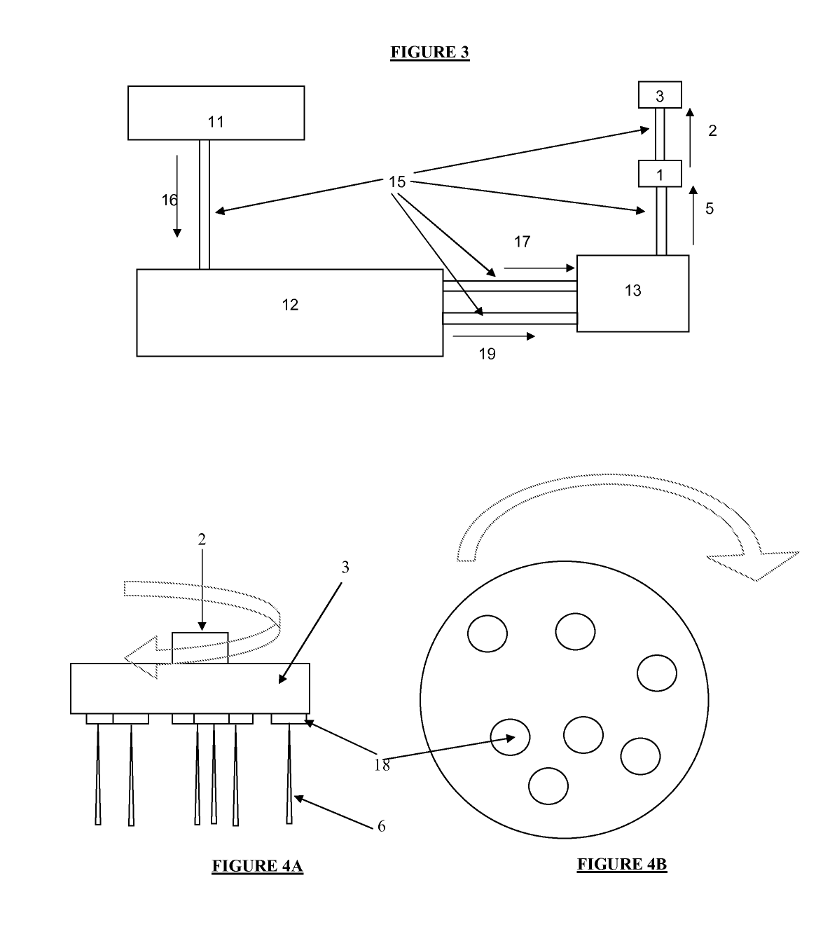

FIG. 3 is an overall block diagram of an installation for dispensing jets of high-pressure fluid at a cryogenic temperature which incorporates a device according to FIG. 1,

and FIGS. 4A and 4B are diagrams of the nozzle-bearing tool of the device in FIG. 1.

FIG. 1 is a schematic (side) view of the part of a device for dispensing jets 6 of high-pressure fluid at a cryogenic temperature, showing the seal 20 of the rotary system 1 and the rotary tool 3. To be more precise, the cylindrical seal 20 is arranged at the intersection of the portions 2, 5 of the feed duct for the liquid nitrogen (LN₂) and is traversed longitudinally by one or more bronze parts 22, 23 and is surrounded by a solid stainless-steel part 21. The seal 20 dynamically seals the rotary system 1 given that the upstream portion 5 is stationary, while the downstream portion 2 is capable of rotational movement.

According to the present invention, the cylindrical rotating seal 20 is a seal made from polymeric material with a coefficient of thermal expansion of between 10.10⁻⁶ and 160.10⁻⁶/K, preferably between approximately 20.10⁻⁶ and 130.10⁻⁶/K. These values are valid and assumed to be constant for the temperature range in question. The coefficients of thermal expansion per unit length are obtained in accordance with DIN 50044.

Table II below gives the coefficients of thermal expansion of, on the one hand, Tivar® and, on the other hand, a number of commercially available polymers which can be used as a seal in the system in FIG. 1 and thus advantageously replace the Tivar® seals that are conventionally used in a cryogenic environment.

TABLE II
Coefficient of thermal expansion (×10⁻⁶/K)

| | PCTFE | | | |
|---|---|---|---|---|
| PTFE | Kel'F ® | PAI | PPS | UHMW PE |
| Teflon ® | Voltalef ® | Torlon ® | Ryton ® | Tivar ® |
| 120 | 70 | 30 | 22 | 180 |

PTFE = polytetrafluoroethylene;
PCTFE = polymonochlorotrifluoroethylene,
PAI = polyamideimide;
PPS = polyphenylene sulfide;
UHMW PE = ultra-high molecular weight polyethylene.

The values in Table II are valid and assumed to be constant for the temperature range in question. The coefficients of thermal expansion per unit length are obtained in accordance with DIN 50044.

Furthermore, the coefficients of friction of the different polymers in Table II and, by way of comparison, of Tivar® are given in Table III below.

TABLE III
Coefficient of dynamic friction
(expressed without units of measurement)

| | PCTFE | | | |
|---|---|---|---|---|
| PTFE | Kel'F ® | PAI | PPS | UHMW PE |
| Teflon ® | Voltalef ® | Torlon ® | Ryton ® | Tivar ® |
| 0.10 | 0.35 | 0.25 | 0.3 | 0.28 |

The coefficient of dynamic friction was determined using DIN 50044. (test on ground hardened steel//P=0.4 MPA−V=0.6 m/s).

As can be seen, PTFE, PCTFE, PAI and PPS have low coefficients of friction of the same order as that for Tivar®.

If the coefficients of thermal expansion and friction are examined, it can be seen that the polymers PS and PAI are the materials that are best suited for producing the rotating seal according to the invention. However, the two other polymers are just as well suited even if they are less preferred.

The system for dispensing cryogenic fluid can be made more reliable by carefully choosing the type of seal 20 to be used in the rotary system 1 of the invention; in other words, the gradual appearance of play between the seal 20 and the metal parts 21, 22, 23 of the rotary system 1 can be prevented or minimized, and hence leaks of nitrogen at said seal 20 can be prevented or minimized.

An installation equipped with a device fitted with a seal according to the invention is shown by way of example in FIG. 3, which can be used, for example, to strip surfaces using jets 6 of cryogenic liquid.

This installation consists of a storage reservoir 11, such as a tank, of liquid nitrogen (referred to hereafter as LN₂) which supplies, via a feed line 16 for liquid nitrogen which is pressurized, i.e. is at a pressure of approximately 3 to 6 bar and a temperature in the order of −180° C., a compression device 12 with an internal upstream compressor and heat exchanger capable of applying an ultra-high pressure (UHP) to the liquid nitrogen. The LN₂ coming from the storage reservoir 1 can thus be compressed by the compression device 12.

The LN₂ at the first pressure (UHP) is then transported via a conveying line 17 to an external downstream heat exchanger 13 where the UHP LN₂ is cooled by liquid nitrogen at atmospheric pressure (at 9), so as to typically obtain UHP liquid nitrogen.

This yields LN₂ at a pressure (UHP) which is typically greater than 1000 bar, generally between 2000 bar and 5000 bar, and advantageously between approximately 3000 and 4000 bar, and at a temperature below −140° C., typically between approximately −140° C. and −180° C., for example in the order of approximately −150 to −160° C., which is sent, via the line portions 5, 2, to the rotary stripping or similar tool 4 fitted with dispensing nozzles 18 delivering jets 6 of UHP liquid nitrogen.

The stationary or movable high-capacity reservoir 11, such as a truck tank or a reservoir for storing several thousands of liters of liquid nitrogen, is generally situated outside buildings, in other words in the open air. The reservoir 11 is joined to the installation by means of heat-insulated pipes comprising one or more check valves. Moreover, the LN₂ is likewise conveyed between the different elements of the system via heat-insulated ducts. The overall gas throughput is approximately 20 l/min, i.e. 15 m³/min.

In general, the compression device 12, the external heat exchanger 13 and especially the tool 4 are in principle situated in one or more buildings.

As illustrated in FIGS. 4A and 4B, in order to strip a surface for example, a tool 4 is used which is equipped with nozzles 18 supplied with UHP LN₂ (at 2) and is preferably rotated so as to obtain jets 6 of UHP LN₂ which are used to strip the surface to be treated.

The downstream portion 2 of duct and the tool 3 are rotated by means of a conventional drive system consisting of a motor and drive pinions or belts.

A heat treatment device equipped with a seal according to the present invention can be applied in any heat treatment operation or method that requires the use of rotating or oscillating jets of cryogenic fluid, in particular for surface treating, stripping or scarifying a material such as metal, concrete, stone, plastic, wood, ceramic, etc.

1-10. (canceled)

11. A device for dispensing at least one jet of high-pressure cryogenic fluid, comprising:
a movable tool which has one or more fluid dispensing nozzles for dispensing one or more jets of a high-pressure fluid at a cryogenic temperature, and
a line for supplying the movable tool with the high-pressure fluid at a cryogenic temperature, the line comprising a stationary upstream portion and a movable downstream portion in fluid communication with the movable tool, wherein the stationary upstream portion and movable downstream portion being fluidically connected to each other by a rotary system comprising a rotating seal made from a polymeric material with a coefficient of thermal expansion of between 10.10⁻⁶/K and 160.10⁻⁶/K.

12. The device of claim 11, wherein the rotating seal comprises a polymeric material with a coefficient of thermal expansion of between 20.10⁻⁶/K and 130.10⁻⁶/K.

13. The device of claim 11, wherein the rotating seal comprises a polymeric material with a coefficient of friction of less than 0.50.

14. The device of claim 11, wherein the seal is cylindrical in shape.

15. The device of claim 11, wherein the seal is held within the rotary system by one or more metal parts.

16. The device of claim 11, wherein the seal is made from a polymeric material chosen from PTFE, PCTFE, PAI and PPS.

17. An installation for dispensing at least one jet of high-pressure fluid at a cryogenic temperature comprising the device of claim 11 that is configured to be supplied with a cryogenic fluid by a source of fluid at a cryogenic temperature and comprising a tool which is capable of rotational movement and is equipped with one or more nozzles configured to dispense said pressurized cryogenic fluid as a jet of high-pressure fluid.

18. A method for surface treating, stripping, or scarifying material using a jet of high-pressure cryogenic fluid, comprising the set of dispensing the jet of high-pressure cryogenic fluid from the device of claim 1 at a surface of a material to thereby treat, strip or scarify the material.

19. The method of claim 18, wherein the cryogenic fluid dispensed by the one or more nozzles of the tool is at a pressure of at least 500 bar.

20. The method of claim 18, wherein the fluid dispensed by the one or more nozzles of the tool is at a temperature of less than −140° C.
